(19) United States
(12) Patent Application Publication
(10) Pub. No.: US 2002/0199207 A1
(43) Pub. Date: Dec. 26, 2002

(54) In-band digital television translator control technology

(76) Inventors: Gomer Thomas, Piscataway, NJ (US); Mark Corl, Princeton Junction, NJ (US)

Correspondence Address: BIRCH STEWART KOLASCH & BIRCH, PO BOX 747, FALLS CHURCH, VA, 22040-0747, US

(21) Appl. No.: 10/126,691

(22) Filed: Apr. 22, 2002

Related U.S. Application Data
(60) Provisional application No. 60/284,870, filed on Apr. 20, 2001.

(51) Int. Cl. H04N 7/173

(52) U.S. Cl. 725/118

(57) ABSTRACT

A method and system for providing certain information associated with at least one signal translator in a digital broadcast environment using an in-band technology are disclosed. The method includes providing the information within a digital broadcast stream. This information is at least one of control information associated with the signal translator and status information pertaining to a status of the signal translator.

The present application claims the priority benefit of U.S. Provisional Application No. 60/284,870 filed Apr. 20, 2001, the entire contents of which are herein fully incorporated by reference.

### BACKGROUND OF THE INVENTION

1. Field of the Invention

The present invention relates to a method and system for providing translator control information within a digital broadcast stream and/or providing status information pertaining to a status of a translator within a translated version of the digital broadcast stream.

2. Discussion of the Related Art

Television translators receive, modify and rebroadcast television signals on new frequencies. Such translators are often used to relay a television broadcast signal over the tops of mountains or ridges to reach viewers in low-lying terrain on the other side. For digital television (DTV), a DTV translator performs at least two main functions: (1) it adds, deletes, or replaces certain information in the broadcast signal, such as virtual channel numbers, and (2) it changes the broadcast frequency to a new broadcast frequency for subsequent receivers. A component or section of the DTV translator that performs the function (1) above is also known as a SI/PSI/PSIP translator. A transmitter of the DTV translator generally performs the function (2) above.

Once the DTV translators are installed, they are expected to operate without interruption for extended periods of time without any type of support or maintenance operations. However, it is necessary to obtain status reports from them periodically to ensure that the translators are operating properly. Also, it may be necessary to send them information from time to time to cause them to alter in various ways the modifications they are making to the signal.

In many instances, the DTV translators operate in remote and sometimes harsh environments that are not easily accessible. Often there is a source of power and no other physical connection. Thus, it can be very costly and even dangerous to visit the site, and it can be very expensive to establish a landbased satellite, or microwave communications link to it. This makes it difficult to send control information and retrieve status reports to and from the SI/PSI/PSIP translator of the DTV translator, rendering the existing DTV translators ineffective with limitations and disadvantages.

In addition, a DTV translator according to a related art relies exclusively upon the use of an out-of-band control technique that would require the translator to: receive control signals for the SI/PSI/PSIP translator using a separate communications path that is different than the television signal it receives for translation; and transmit/output status signals from the SI/PSI/PSIP translator using a separate communications path that is different than what is used for the translated television signal being rebroadcast. As a result, multiple communication paths are required and must be maintained in such a translator system, which complicates the system and increases the cost associated with the system.

### SUMMARY OF THE INVENTION

The present invention provides a method and system for providing translator control information and/or translator status information, which overcome the problems and disadvantages associated with the related art.

The present invention provides, among other things, a solution to the problems described above by conveying translator control signals and translator status reports in a digital data stream such as a digital television (DTV) multiplex signal itself. This is considered an in-band control technique.

The present invention provides in-band control technology that can eliminate, or be used in conjunction with, out-of-band control technology.

Translator technology according to an embodiment of the present invention uses industry-standard mechanisms (e.g., TCP/IP or UDP/IP) to encode the translator control information to an “in-line” device.

Translator technology according to an embodiment of the present invention uses industry-standard mechanisms (e.g., IP address and port number) to select each remote system uniquely.

Translator technology according to an embodiment of the present invention obtains status data from a remote translator system without a physical connection.

Translator technology according to an embodiment of the present invention uses industry-standard mechanisms (e.g., TCP/IP or UDP/IP) to insert translator status information from the generating device into the digital broadcast stream.

Translator technology according to an embodiment of the present invention provides a means of controlling multiple translators in series, in parallel, or in combinations.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention and wherein:

FIG. 1A is a diagram of a broadcast environment in which translators are arranged in parallel according to an embodiment of the present invention.

FIG. 1B is a diagram of a broadcast environment in which translators are arranged in series according to an embodiment of the present invention.

FIG. 1C is a diagram of a broadcast environment in which translators are arranged both in parallel and series according to an embodiment of the present invention.

FIG. 2 is a functional block diagram of a translator system according to an embodiment of the present invention.

### DETAILED DESCRIPTION OF THE PREFERRED EMBODIMENTS

In the present invention, translators used in a broadcast environment are arranged in parallel, in series, or a combination thereof. At the initial broadcast station where signals are broadcast in digital broadcast streams such as MPEG-2 transport streams, digital TV streams, etc., the present invention inserts control information for each translator within the digital broadcast stream. The control information includes information needed by each translator to translate the broadcast signals and any other information for controlling the operation of one or more components of the translator.

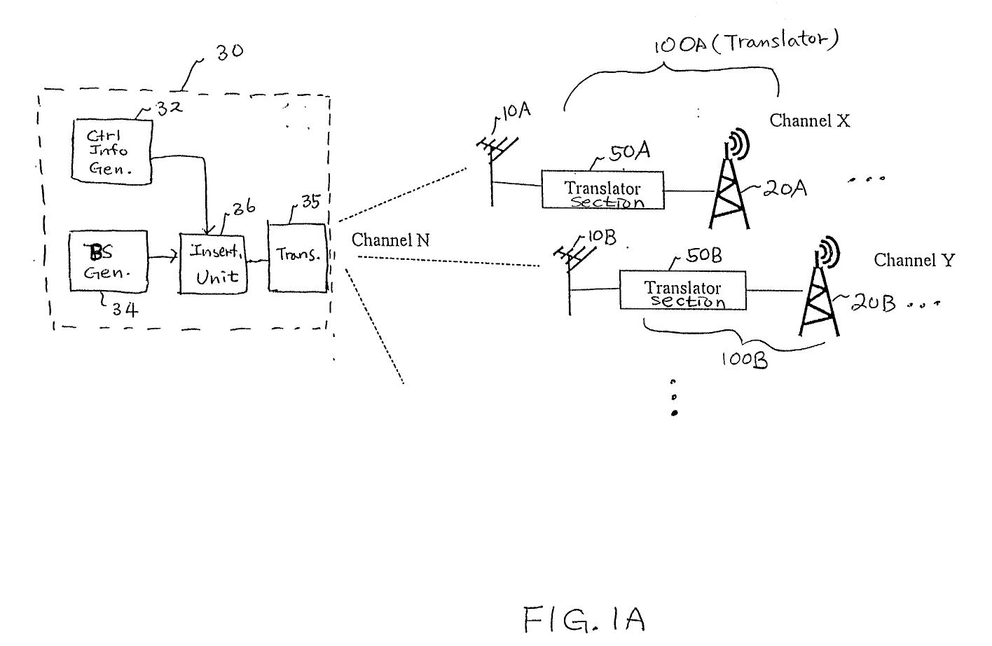

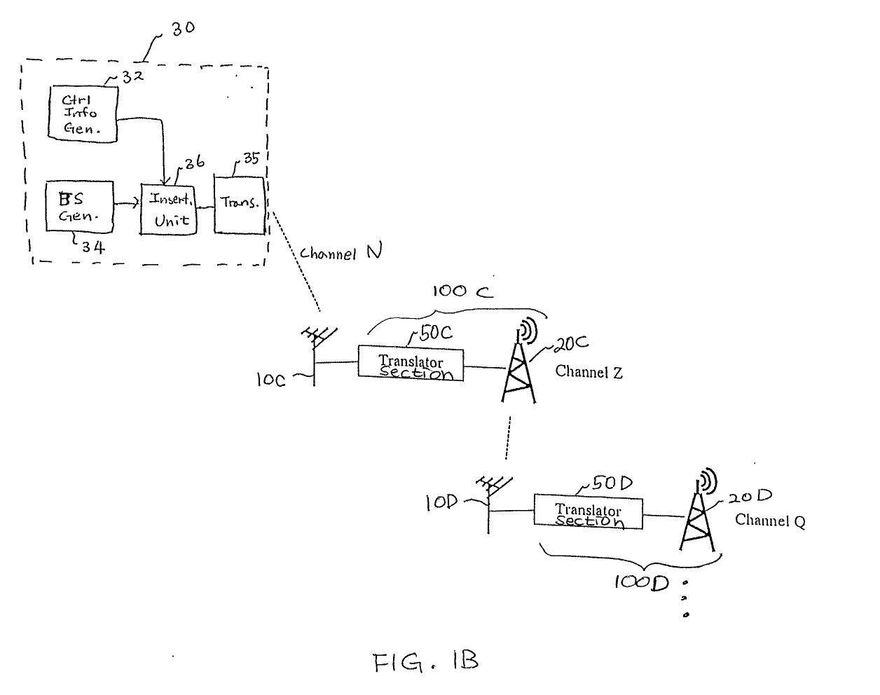

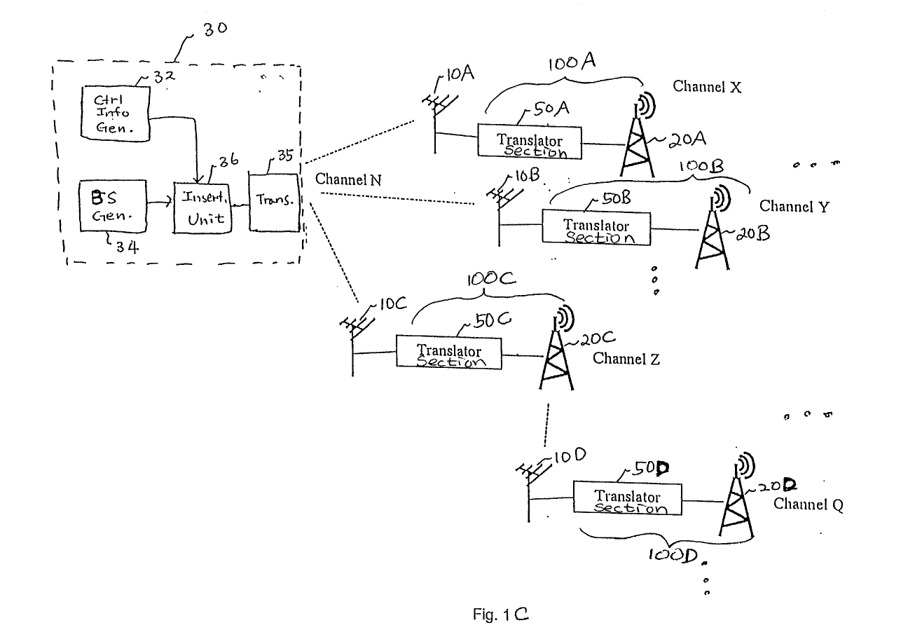

FIGS. 1A, 1B and 1C are diagrams of a broadcast environment in which translators are arranged in parallel, in series, and a combination of the series and parallel arrangement, respectively, according to embodiments of the present invention. As shown in FIGS. 1A-1C, a broadcast system 30 includes a broadcast stream (BS) generator 34, a control information generator 32 generating translator control information, an insertion unit 36, and a transmitter 35, all operatively coupled. The broadcast system 30 may also include any other known components present in conventional broadcast systems, such as a scheduler, a database, etc.

The BS generator 34 generates a digital broadcast stream such as a MPEG-2 transport stream or digital TV stream. The control information generator 32 generates control information for controlling one or more different translators 50 (50A, 50B, 50C, 50D . . . ). In certain situations, the control information generator 32 may generate a lookup table which will be discussed later in detail. The insertion unit 36 inserts the control information (and the lookup table) within the digital broadcast stream using known insertion techniques, and the digital broadcast stream with the inserted control information is then broadcast to a plurality of receivers 10 (10A, 10B, 10C, 10D . . . ) using the transmitter 35. Here, other known processes may occur in the broadcast system 30 according any other known components which may be present in the broadcast system 30.

Then one or more receivers 10 receive this digital broadcast stream according to their arrangement. The received broadcast stream is processed by translators 100 (100A, 100B, 100C, 100D . . . ) which are arranged in series, in parallel, or a combination thereof. Each of the translators 100 includes a translator section 50 (50A or 50B or 50C or 50D . . . ) which is also termed herein as a SI/PSI/PSIP translator, and a transmitter 20 (20A or 20B or 20C or 20D . . . ). Each translator section 50 adds, modifies or replaces certain information in the digital broadcast stream as needed. Particularly, each translator section 50 extracts the control information (i.e., the translator control information) intended for it and ignores any other control information intended for other (downstream/parallel) translators. Each transmitter 20 modulates the broadcast stream received from the corresponding translator section 50 using any known modulation methods (e.g., VSB, COFDM, etc.), upconverts it to a new output frequency, and then transmits it. Based on the extracted control information, each of the translators 100 translates the signals in the received broadcast stream, and the translated broadcast stream signal is then rebroadcast to a next receiver. That is, each translator 50 merely passes along the other translator control data in its translated digital broadcast stream, just as it passes on other data in the received digital broadcast stream that do not need a translation.

In addition, optionally, each translator section 50 embeds its corresponding translator status information within the translated broadcast stream before it is rebroadcast. A translator or receiver at the receiving end can be configured to extract the embedded status information, if needed. For instance, if the translator A rebroadcasts the translated broadcast stream with the status information pertaining to the translator A to a receiver B, then a translator B or the receiver B can extract the status information of the translator A as needed, perform its translation function (by the translator B), and pass on the twice-translated broadcast stream which may contain status information pertaining to the translator B. But if the status information on the translator A is not needed by the translator/receiver B, then the translator/receiver B would ignore, i.e., merely pass along, the status information of the translator A as part of its translated broadcast stream, just as it would for the remainder of the received broadcast stream.

Accordingly, in the present invention, the control and/or status information is provided within the digital broadcast stream. This “in-band” type technology overcomes problems associated with the related art.

In accordance with an embodiment, there are at least three types of translator status data associated with the translator section that can be generated in the present invention. The translator status data embedded in the digital broadcast stream may include one or more of these types of data, but is not limited to such. The first type of status data is a simple statistics message. Periodically the translator section can send out information about how many virtual channels it translated. The second type of status data is an indication of failure. There are a number of failure modes (e.g., can't find the requested virtual channel, missing VCT, etc.). The translator will still send the digital broadcast stream through, but the digital broadcast stream will not be translated. The failure indication could indicate why. The third type of status data is a warning regarding non-compliance with ATSC, MPEG or other relevant standards. A translator may test tables for timing compliance and issue warnings when tables are not received (and therefore presumably not sent) frequently enough. The translator or its system may also check for broadcast stream problems such as continuity count errors, packet errors and such.

To address each of the translator sections or translators so that each translator knows how to extract the translator control data intended for it and to ignore other translator control data, the present invention provides the following addressing techniques. In accordance with a first addressing technique of the present invention, each translator is assigned with a unique identification number, and the control information for each translator is placed into one of the data packets of the digital transport stream that has the same identification as the corresponding translator's identification. For instance, the control information for each translator is placed in one of MPEG-2 transport stream packets whose packet identification (PID) is set to be the same as the translator's identification number. This has the advantage that the translator can ascertain which packets contain information relevant to the frequency translation that it needs without having to decode/decompose the entire packet payload, thereby lowering the computational load on the translator.

In accordance with a second addressing technique of the present invention, the control information for different translators is placed in Internet Protocol (IP) packets all encapsulated in MPEG-2 transport packets having the same PID (e.g., PID #123) designated for control information packets. But each IP packet contains a unique and different destination IP address assigned to a particular translator. Thus, the control information for each of the translators is placed in one or more of these IP packets having the destination IP address designating the corresponding translator. In another example, each IP packet contains both a unique and different destination IP address and destination port number assigned to a particular translator. Here, the port number may be, but is not limited to, a TCP or UDP port number if the IP packets are TCP/IP or UDP/IP type packets. Thus, the control information for each of the translators would be placed in one or more of the IP packets having the destination IP address and port number designating the corresponding translator. These IP packets are encapsulated within transport stream packets such as MPEG-2 transport stream packets.

Thus, when each translator receives the transport stream packets, it locates the IP packets having the PID designated for control information packets (in this example, PID #123). Then among the located IP packets, the translator parses through the IP packets to find an IP packet with a particular destination IP address or a combination of a destination IP address and destination port number designating that translator. Once such an IP packet is found, the translator obtains the information in that IP packet, which should be the control information specific for that translator.

The source of the broadcast includes all of the control information necessary for all of the attached translators. Each of the translators then only decodes the control data intended for it by decoding the IP stream and watching for its address.

This second addressing technique may be computationally less advantageous than the first addressing technique in some circumstances, because it requires reconstruction of IP packets from the (MPEG-2) transport stream packets in order to locate an IP packet that contains control information specific for that translator. However, an advantage of identifying translator control information data packets by using IP address and port is that control of the translator can be made independent of the physical and data link networking layers. As such, the second addressing technique can be applied in contexts other than digital television broadcasting.

In accordance with a third addressing technique of the present invention, a lookup table or announcement table for identifying what types of data are contained in transport stream packets having a given packet identifier or PID within a digital transport/broadcast stream is generated based on the relevant broadcasting standard (ATSC, DVB, etc.). The announcement table would associate each of the translators (assigned with a unique translator identifier) with a particular packet identifier or PID identifying the data packet carrying the control information for that translator or a particular IP address or any other identifying parameter of the transport layer. According to this technique, the translator would search the announcement table, identify the PID or other identifying parameter associated with the translator identifier for that translator, and then go to the data packet having the identified PID/parameter to get its control information. In this case the control information would not have to be IP-based. In other words, instead of having a fixed mapping of PIDs to translators, IP addresses/ports to translators, or more generally values of some transport level parameter to translators, in this embodiment a lookup table can be inserted in the broadcast stream, where each translator can look up in the table for the currently assigned value associated with the desired packet containing the control information specific for that translator. As a result, the third addressing technique allows the addressing relationship between control information packets and translators to be easily modifiable at any given time, if needed.

In accordance with one embodiment, one form of the lookup table could be a known service discovery mechanism such as the “Data Service Table” specified in the ATSC Data Broadcast Standard that is known in the art. Alternatively, the lookup table could be a private table in some fixed location (pre-defined PID and/or multicast address/port), or all translators could locate a private lookup table by using service discovery mechanisms provided in the DTV data broadcasting standards, rather than having some fixed location for it in the broadcast stream. Obviously, other variations are possible.

In accordance with one embodiment, the control information includes which values carried in the digital broadcast stream need to be changed and the new values that should be used. Additionally, the control information can request specific status information that may be more verbose or descriptive than the status information provided during a normal operation.

Similar to the techniques of addressing translator sections or translators with respect to the control information packets, there are several ways to identify the translator section or translator associated with each status information/message according to the embodiments of the present invention and they are: (1) The status information for different translators is put in digital broadcast stream packets (e.g., MPEG-2 transport stream packets) with a packet identifier or PID corresponding to the translator's identification number. (2) The status information for different translators is carried appropriately in IP packets each with either a source IP address or a combination of the source IP address and source port number identifying the corresponding translator. Such IP packets may be identified by using one same PID. Here, the port number may be, but is not limited to, a TCP or UDP port number if a TCP/IP or UDP/IP type data packet is used. (3) The status information for different translators can be assigned to different packet identifiers, PIDs or any other identifying parameters where an announcement table maps the association between the identifying parameters and translators.

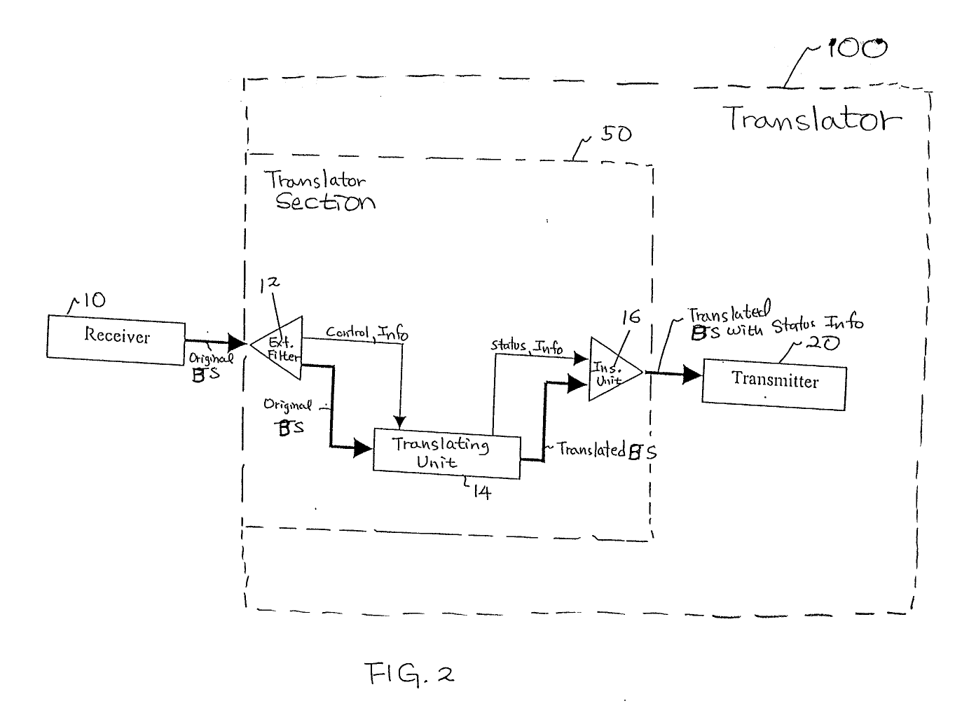

FIG. 2 is a functional block diagram of the translator 100 usable in the environments shown in FIGS. 1A-1C in accordance with an embodiment of the present invention. As shown in FIG. 2, the translator 100 includes a translator section 50 and a transmitter 20, all operatively coupled. The translator section 50 includes an extraction filter 12, a translating unit 14, and an insertion/encapsulation unit 16, all operatively coupled. In another embodiment, the translator 100 may include the receiver 10. In still another embodiment, a separate frequency upconverter may exist in addition to the transmitter.

Particularly, the receiver 10 receives an original digital broadcast stream (BS) such as MPEG-2 transport stream or digital TV stream. This BS includes the control and/or status information provided according to the first, second, or third addressing techniques discussed above. If the third addressing technique is used, the BS would include an announcement table as discussed above.

An extraction filter 12 then extracts appropriate control information from the original BS. This process may vary depending on which addressing technique has been implemented, and can be performed using any known extraction process. For instance, if the first addressing technique has been implemented, then the extraction filter 12 would look for a packet with the same PID as the translator 50's ID from the received BS. If the second addressing technique has been implemented, the extraction filter 12 may look for an IP packet with a particular destination IP address and port number assigned to the translator section 50 or translator 100. If the third addressing technique has been implemented, the extraction filter 12 would look into the announcement table in the received BS, obtain the appropriate PID or IP address or any other identifying parameter value for the translator section 50 or translator 100 from the table, and extract the data accordingly. The extracted data packet is decoded using known decoding methods, so that the translator 100 can obtain the control information carried in that packet. The extraction filter 12 sends the obtained control information and the received BS to the translating unit 14.

The translating unit 14 translates the received BS according to the obtained control information. For instance, the translating unit 14 translates the virtual channel numbers of the channels carried in the BS into new channel numbers provided in the control information, and generates the translated BS. The translating unit 14 may also generate the translator status information as discussed above. Then the insertion unit 16 inserts the status information into the translated BS. This can be accomplished using known techniques for inserting or adding data into a digital data stream. Then the transmitter 20 broadcasts the translated BS with the inserted status information for a next receiver using known techniques. For instance, the transmitter 20 may modulate the translated BS, upconvert the modulated translated BS to an output frequency, and transmit it. As discussed above, the transmitter 20 may change the output frequency of the translated BS to a new frequency. This new frequency information may be contained in the received BS and may be extracted by the transmitter 20 or any designated element such as a separate frequency upconverter.

As an addition or alternative to the above described embodiments, the technique of providing and extracting control information and/or status information associated with the translator section 50 according to the present invention can be applied to any other component of the translator 100, a translator system or a digital broadcast environment. For instance, the same technique can be applied to provide and extract control information and/or status information associated with the transmitter 20, e.g., for setting or varying power levels of the transmitter 20, setting the RF output frequency for the transmitter 20, etc. As an example only, the BS 30 can insert control information (e.g., a new output frequency or new power level) for controlling the operation of the transmitter 20. In one implementation as an example, different subscripts with the same base identifiers can be used to distinguish the control information for the translator section 50 and the control information for the transmitter 20, both belonging to the same translator 100. Obviously, other variations are possible and contemplated as part of the present invention. Accordingly, the present invention is applicable to any system wherein a modification of certain information in a digital broadcast stream is desired.

Although separate blocks have been used to depict the extraction filter 12, the translating unit 14, and the insertion unit 16, these may be integrated into one component. Similarly, the translator section 50 may also be integrated with the receiver 10 and/or the transmitter 20.

In the present invention, the receivers 10 can be any of the known receivers or transceivers, and the transmitter 35 can be any known transmitter or transceiver. Further, the translating unit 14 can include components of any known translating unit. Overall, any known hardware and/or software can be used and/or modified to implement all aspects of the present invention, and various ways of implementation are intended to be part of the present invention. In addition, any computer programming language can be used to implement computer-executable functions of the present invention.

In one embodiment, special monitoring receivers may be located in the target viewing area. These monitoring receivers would tune to the appropriate frequency of the translated digital data streams, extract the status information, and send the extracted status information to a central monitoring station over existing communications links such as dial-up phone lines. Generic operating data would be included, as part of the status data, in the data stream under normal operation but extended status data could be included on an as-requested basis.

In one embodiment, the PID or PIDs containing the control and/or status information would appear in a separate “hidden” virtual channel, so that such information would not interfere with the operation of normal TV receivers.

In addition, details emitted by the translator can be selected through the control messages according to an embodiment of the present invention. For instance, the broadcaster can control one or more translators to generate “verbose” status information when more detailed trouble-shooting is necessary. In this case, the translator would only need to use extra bandwidth when requested.

One simple example of the present invention will now be discussed to enhance understanding. Suppose that a broadcast station needs to reach customers in three regions. The only way for the signal to reach the farthest region is to be rebroadcast twice. Suppose also that the station is allowed to broadcast on three different frequencies, one for each region. So the initial broadcast (Region 1) is on channel 32, Region 2 is supported by Channel 45, and Region 3 is supported by Channel 28. Then, the translator from Region 1 to Region 2 (Translator A) must translate Channel 32 to 45 and the translator from Region 2 to Region 3 (Translator B) must translate Channel 45 to 28. Using the broadcast control mechanism described herein, the initial broadcast includes control information for both translators using separate IP addresses. The control information addressed to Translator A contains information on how to translate the broadcast signal on Channel 32 to Channel 45 and the control information addressed to Translator B contains instructions on how to translate the broadcast signal on Channel 45 to Channel 28. Translator A simply ignores (and therefore passes through) all information concerning Translator B. Translator B ignores (and passes through) any status information supplied by Translator A. Thus, a receiver in Region 3 could tune to Channel 28, receiving the broadcast initially provided on Channel 32 and obtain status data from both Translator A and Translator B.

Accordingly, the present invention allows a plurality of translators to be controlled even if a given translator does not directly receive the signal of the initial controlling broadcast. This is because the control information is addressed for a single translator and contains information concerning what needs to be changed based on the environment of the particular translator. Further, the present invention provides all control and/or status information for different components of different translators within the digital broadcast stream, thereby providing “in-band” digital TV/data translator control technology.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of providing certain information associated with at least one signal translator in a digital broadcast environment, the method comprising:
providing said information within a digital broadcast stream, said information being at least one of control information associated with the at least one signal translator and status information pertaining to a status of the at least one signal translator.

2. The method of claim 1, wherein the at least one signal translator includes a plurality of signal translators, and said information includes a plurality of control information pieces each associated with one of the signal translators, and wherein the method further comprises:
associating each of the control information pieces with one of the signal translators using at least one identifier in the form of a transport layer parameter value assigned to said signal translator; and
selectively accessing, by the signal translators, the control information pieces from the digital broadcast stream using the at least one identifier, such that each of the signal translators accesses the corresponding control information piece and passes on all other control information pieces.

3. The method of claim 2, wherein, in the associating step, each of the control information pieces is placed in one or more MPEG-2 transport stream packets with a unique PID (packet identifier) value that is assigned to one of the signal translators, wherein the MPEG-2 transport stream packets are carried in the digital broadcast stream.

4. The method of claim 2, wherein, in the associating step, each of the control information pieces is placed in one or more IP (Internet Protocol) packets that have a unique IP destination address or a unique combination of IP destination address and port number that is assigned to one of the signal translators, wherein the IP data packets are carried in the digital broadcast stream.

5. The method of claim 2, wherein the associating step includes:
providing a lookup table which is generated and embedded within the digital broadcast stream, said lookup table giving a mapping from a unique identifier of each of the signal translators to a value of a transport layer parameter assigned to the control information pieces associated with that signal translator.

6. The method of claim 1, wherein the at least one signal translator includes a plurality of signal translators, and said information includes a plurality of status information pieces each pertaining to a status of one of the signal translators and being carried in at least once translated version of the digital broadcast stream generated by the corresponding signal translator, and wherein the method further comprises:
associating each of the status information pieces with one of the signal translators using at least one identifier in the form of a transport layer parameter value assigned to said signal translator; and
selectively accessing, by receivers, the status information pieces from the digital broadcast stream using the at least one identifier, such that each of the receivers accesses one or more desired status information pieces associated with each of one or more signal translators.

7. The method of claim 6, wherein, in the associating step, each of the status information pieces is placed in at least one MPEG-2 transport stream packet with a unique PID (packet identifier) value that is assigned to one of the signal translators, wherein the MPEG-2 transport stream packets are carried in the translated version of the digital broadcast stream.

8. The method of claim 6, wherein, in the associating step, each of the status information pieces is placed in one or more IP (internet protocol) packets having either an IP address or a combination of an IP address and a port number that is assigned to the corresponding signal translator, wherein the IP packet is carried in the translated version of the digital broadcast stream.

9. The method of claim 6, wherein the associating step includes:
providing a lookup table which is generated and embedded within the translated version of the digital broadcast stream, said lookup table giving a mapping from a unique identifier of each of the signal translators to a value of a transport layer parameter assigned to the status information pieces associated with that signal translator.

10. The method of claim 9, wherein at least one of the status information pieces is at least one of:
statistical data on the corresponding signal translator;
translation failure indication; and
indication of non-compliance with at least one standard with which the broadcast signal should be compliant.

11. The method of claim 10, wherein the statistical data indicates what information in the broadcast stream was translated, and the non-compliance indication contains information on at least one of inadequate table transmission frequency, continuity count errors, and packet errors.

12. The method of claim 1, wherein the digital broadcast stream is either a digital television stream or an MPEG-2 transport stream.

13. The method of claim 1, wherein the at least one signal translator includes a transmitter and a translator section, and at least one of the control information and the status information is associated with at least one of the transmitter and the translator section.

14. A broadcast system for providing a plurality of control information pieces each associated with one of a plurality of signal translators in a digital broadcast environment, the system comprising:
a first generator generating a digital broadcast stream;
a second generator generating the plurality of control information pieces corresponding to the signal translators;
an insertion unit inserting the plurality of control information pieces within the digital broadcast stream according to a predetermined association between the control information pieces and values of a transport level parameter that are assigned to the signal translators; and
a transmitter broadcasting the digital broadcast stream with the inserted control information pieces.

15. The system of claim 14, wherein the insertion unit places each of the control information pieces into at least one MPEG-2 transport stream packet with a unique PID (packet identifier) value that is assigned to one of the signal translators, and the MPEG-2 transport stream packets are inserted within the digital broadcast stream.

16. The system of claim 14, wherein the insertion unit inserts each of the control information pieces into at least one IP data packet having either an IP destination address or a combination of an IP destination address and a port number which has been assigned to the corresponding signal translator, and the IP packets are inserted within the digital broadcast stream.

17. The system of claim 14, wherein the second generator generates a lookup table and the insertion unit embeds the lookup table within the digital broadcast stream, the lookup table giving a mapping from a unique identifier of each of the signal translators to a value of a transport layer parameter assigned to the corresponding control information pieces.

18. The system of claim 14, wherein the digital broadcast stream is either a digital television stream or an MPEG-2 transport stream.

19. The system of claim 14, wherein each of the signal translators includes a translator section and a transmitter, and the control information pieces are associated with at least one of the translator sections and the transmitters.

20. A signal translator usable in a digital broadcast environment for translating a digital broadcast stream, the translator comprising:
an extractor receiving a digital broadcast stream carrying both a broadcast signal and a plurality of control information pieces associated with a plurality of signal translators, the extractor extracting at least one of the control information pieces assigned to the present signal translator from the digital broadcast stream; and
a translating unit translating the digital broadcast stream based on the extracted control information piece and thereby generating a translated digital broadcast stream.

21. The signal translator of claim 20, wherein the extractor extracts the at least one of the control information pieces based on a transport layer parameter assigned to the present signal translator.

22. The signal translator of claim 20, wherein the extractor extracts the at least one of the control information pieces by searching MPEG-2 transport stream packets contained in the received digital broadcast stream using a PID value assigned to the present signal translator.

23. The signal translator of claim 20, wherein the extractor extracts the at least one of the control information pieces by looking up a lookup table contained in the received digital broadcast stream and identifying a location of the one of the control information pieces based on a transport layer parameter assigned to the present signal translator.

24. The signal translator of claim 20, wherein the extractor extracts the at least one of the control information pieces by searching IP (internet protocol) data packets contained in the received digital broadcast stream using either a destination IP address or the destination IP address and a port number assigned to the present signal translator.

25. The signal translator of claim 20, wherein the translator contains a reporter in addition to, or instead of, the extractor, and the reporter generates status information pertaining to a status of the present signal translator, and inserts at least one status information piece within the translated digital broadcast stream.

26. The signal translator of claim 25, wherein the reporter inserts the at least one of the control information pieces using a value of a transport level parameter that is assigned to the present signal translator.

27. The signal translator of claim 25, wherein the reporter inserts the status information within the translated digital broadcast stream using one of the following:
1) placing the status information in at least one MPEG-2 transport stream packet having a PID (packet identifier) value that is assigned to the present signal translator;
2) placing the status information in at least one IP packet having either a source IP (internet protocol) address or a combination of the source IP address and a port number identifying the present signal translator; or
3) placing the status information in at least one data packet according to information provided in a lookup table that associates the present signal translator with that at least one data packet.

28. The signal translator of claim 20, further comprising:
a transmitter receiving the translated digital broadcast stream from the translating unit, modifying the translated digital broadcast stream based on the corresponding control information piece, and rebroadcasting the modified digital broadcast stream.

29. The signal translator of claim 20, wherein the digital broadcast stream is either a digital television stream or an MPEG-2 transport stream.

30. A computer program product embodied on computer-readable media for providing certain information associated with at least one signal translator in a digital broadcast environment, the computer program product comprising computer executable instructions for:
providing said information within a digital broadcast stream, said information being control information associated with the at least one signal translator.

31. The computer program product of claim 30, wherein the at least one signal translator includes a plurality of signal translators, and said information includes a plurality of control information pieces each associated with one of the signal translators, and wherein the computer program product further comprises computer executable instructions for:
associating each of the control information pieces with one of the signal translators using at least one identifier in the form of a transport layer parameter value assigned to said signal translators.

32. The computer program product of claim 31, wherein the unique translator identifier of each of the signal translators identifies at least one MPEG-2 transport stream packet carrying the corresponding control information piece, wherein the MPEG-2 transport stream packets are carried in the digital broadcast stream.

33. The computer program product of claim 30, wherein the computer executable instructions for associating include computer executable instructions for:
associating each of the signal translators with either an IP (internet protocol) address or a combination of the IP address and a port number identifying at least one IP data packet carrying the corresponding control information piece, wherein the at least one IP data packet is carried in the digital broadcast stream.

34. The computer program product of claim 30, wherein the computer executable instructions for associating include computer executable instructions for:
generating and embedding a lookup table within the digital broadcast stream, the lookup table giving a mapping from a unique identifier of each of the signal translators to a value of a transport layer parameter assigned to the corresponding control information piece.

35. A computer program product embodied on computer-readable media for providing certain functionality associated with a signal translator in a digital broadcast environment, the computer program product comprising computer executable instructions for at least one of:
providing status information within a digital broadcast stream, said status information pertaining to a status of the said signal translator; and
extracting control information from a digital broadcast stream, said control information being the control information associated with the signal translator.

36. The computer program product of claim 35, wherein the said status information includes at least one status information piece pertaining to a status of said signal translator and being carried in an at least once translated version of the digital broadcast stream generated by the said signal translator, and wherein the computer program product further comprises computer executable instructions for:
associating each of the status information pieces with said signal translator using at least one identifier in the form of a transport layer parameter value assigned to said signal translator.

37. The computer program product of claim 36, wherein the computer executable instructions for associating include computer executable instructions for:
placing each of the status information pieces in at least one MPEG-2 transport stream packet having a PID (packet identifier} corresponding to an identifier of the said signal translator, wherein the data packet is carried in the translated version of the digital broadcast stream.

38. The computer program product of claim 36, wherein the computer executable instructions for associating include computer executable instructions for:
placing each of the status information pieces in an IP (internet protocol) packet having either an IP address or a combination of the IP address and a port number identifying said signal translator, wherein the IP packet is carried in the translated version of the digital broadcast stream.

39. The computer program product of claim 36, wherein the computer executable instructions for associating include computer executable instructions for:
placing the status information in at least one data packet in the digital broadcast stream according to information provided in a lookup table that associates said signal translator with said at least one data packet.

40. The computer program product of claim 36, wherein at least one of the status information pieces is at least one of:
statistical data on the corresponding signal translator;
translation failure indication; and
indication of non-compliance with at least one standard with which the broadcast signal should be compliant.

41. The computer program product of claim 35, wherein the said control information includes at least one control information piece pertaining to said signal translator and being carried within a digital broadcast stream, and wherein the computer program product further comprises computer executable instructions for:
extracting at least one information piece associated with said signal translator using at least one identifier in the form of a transport layer parameter value assigned to said signal translator.

42. The computer program product of claim 41, wherein the at least one of the control information pieces is extracted by searching MPEG-2 transport stream packets contained in the received digital broadcast stream using a PID value assigned to the present signal translator.

43. The computer program product of claim 41, wherein the at least one of the control information pieces is extracted by looking up a lookup table contained in the received digital broadcast stream and identifying a location of the one of the control information pieces based on the transport layer parameter assigned to the present signal translator.

44. The computer program product of claim 41, wherein the at least one of the control information pieces is extracted by searching IP (internet protocol) data packets contained in the received digital broadcast stream using either a destination IP address or the destination IP address and a port number assigned to the present signal translator.

45. The computer program product of claim 35, wherein the digital broadcast stream is either a digital television stream or an MPEG-2 transport stream.

46. The computer program product of claim 35, wherein the at least one signal translator includes a transmitter and a translator section, and at least one of the control information and the status information is associated with at least one of the transmitter and the translator section.

47. The computer program product of claim 30, wherein the digital broadcast stream is either a digital television stream or an MPEG-2 transport stream.

48. The computer program product of claim 30, wherein the at least one signal translator includes a transmitter and a translator section, and at least one of the control information and the status information is associated with at least one of the transmitter and the translator section.
